(19) United States
(12) Patent Application Publication
(10) Pub. No.: US 2011/0086327 A1
(43) Pub. Date: Apr. 14, 2011

(54) Combination UCLA Impression Coping and Installation Procedure

(76) Inventors: Sheldon Lerner, Woodmere, NY (US); Albert Zickmann, Chicago, IL (US)

(21) Appl. No.: 12/576,272

(22) Filed: Oct. 9, 2009

(51) Int. Cl. A61C 9/00; A61C 8/00; B29C 45/14

(52) U.S. Cl. 433/173; 433/214; 264/279

(57) ABSTRACT

A UCLA castable abutment and impression taking component are combined into one unit. The shape of the plastic distal end of the UCLA abutment is fabricated so that it will have one or more undercuts as well as one or more anti-rotation features to allow it to be used while taking an impression of the abutment's relationship to the implant using the indirect transfer method. The combination of an anti-rotation and undercut feature allow the UCLA abutment to be gripped by the impression. The unit includes a bore to allow a fixation screw to fixate the unit to either an implant or implant analog.

### FIELD OF THE INVENTION

The present invention relates generally to the field of restorative dentistry and more particularly, to a combination impression coping and an associated installation procedure.

### BACKGROUND OF THE INVENTION

Dental implants are used to provide a platform to which a dental prosthesis may be secured to underlying bone in the mandible or maxilla of a dental patient. A typical root form dental implant system employs a dental implant that is placed in a prepared site in the underlying bone. A cover screw is affixed to the top of the implant and the bone surrounding the prepared site is allowed to grow into the implant for several months, thereby securing the implant to the bone.

Once the surrounding bone has sufficiently engaged the implant, the cover screw is removed and an impression coping is affixed to the implant. An impression of the implant-impression coping assembly and the surrounding teeth is taken and a dental prosthesis is constructed using the impression as a model of the area of the patient's mouth surrounding the implant site.

One method of taking an impression is the closed tray method. With the closed tray method impression material is placed in a tray and then placed around the implant and allowed to set. Once it has set, the tray and the impression material are removed from the patient's mouth, with the impression coping still affixed to the implant. The impression coping is removed from the patients mouth and the impression coping is attached to an analog duplicate of the implant. Because the impression coping has antirotation as well as undercut features it can be snapped back into the impression in an accurate fashion. The assembly of the impression coping and analog is then ‘snapped’ into the rubber impression. A stone or plaster is poured in to the rubber impression-implant impression coping/analog assembly to create a model of the patients mouth and implant. The model of the implant and the patient's mouth is used so that a prosthesis may be constructed. Typically, the impression coping is discarded.

Alternatively an open tray technique can be used for the impression where there is a hole at the top of the tray. Rubber is poured into the tray and the tray is seated in the mouth. While the rubber has not completely set, the dentist will clear away the rubber from around the top of the impression coping so he or she can access the fixation screw that holds the impression coping in place. Once the rubber has set the dentist loosens the fixation screw. When the dentist removes the impression tray from the mouth it will remove the impression coping at the same time. The analog of the implant is then attached to the captured impression coping. A cast model is made from the impression. Once the model has been made, there are a multitude of different abutment options. An abutment is a structure that extends from the implant to which the prosthesis is secured.

One such popular option is a UCLA abutment. This abutment consists of a machine made metal section which precisely fits to the implant and a plastic tube that extends distal from the metal section. This plastic section is reshaped and added to by a laboratory technician. The combination of metal and custom shaped plastic extender is then removed from the model and the base. Although this method is convenient for the implantologist and technician, it has several disadvantages. One is that a separate component must be used to make the impression of the patients' mouth. This increases cost. In addition, the use of a separate component makes it difficult for the prosthesis maker to precisely align the prosthesis with the implant and the castable UCLA abutment during the prosthesis-making process.

Once made, the dental prosthesis is affixed to the abutment with cement, or other affixing means. Thus, the abutment acts as a platform for securing a dental prosthesis to the implant.

### OBJECTS AND SUMMARY OF THE INVENTION

It is an object of the present invention to provide a combination UCLA impression coping which provides a medically sound implant while resulting in significant cost savings.

Another object of the present invention is to provide a combination UCLA impression coping and an associated installation procedure which results in a significant time saving for the dentist and the dental technician.

Another object of the present invention is to eliminate the discarding of conventional impression copings.

Another object of the present invention is to provide a combination UCLA impression coping which can be used as a temporary abutment.

Yet another object of the present invention is to provide a combination UCLA impression coping which can be manufactured at a relatively low unit cost.

Additional objects and advantages of the invention will be made clear hereinafter.

One aspect of the invention includes combining a UCLA castable abutment and impression taking component into one unit. The shape of the plastic distal end of the UCLA abutment is fabricated so that it will have one or more undercuts as well as one or more anti-rotation features to allow it to be used while taking an impression of the abutment's relationship to the implant using the indirect transfer method. The combination of an anti-rotation and undercut feature allow the UCLA abutment to be gripped by the impression. The combination UCLA impression coping includes a bore to allow a fixation screw to fixate the invention to either an implant or implant analog.

These and other aspects of the invention will become apparent from the following description of the preferred embodiment taken in conjunction with the following drawings, although variations and modifications may be affected without departing from the spirit and scope of the novel concepts of the disclosure.

### BRIEF DESCRIPTION OF THE DRAWINGS

FIG. 1 is an overall perspective view of a combination UCLA impression coping;

FIG. 2 is an overall perspective view of the impression coping of FIG. 1 taken from an alternative point of view;

FIG. 3 is a side elevation view taken along the line 3-3 of FIG. 1;

FIG. 4 is a view taken along the line 4-4 of FIG. 1;

FIG. 5 is a view taken along the line 5-5 of FIG. 1;

FIG. 6 is a perspective view of the substructure member of the impression coping of FIG. 1;

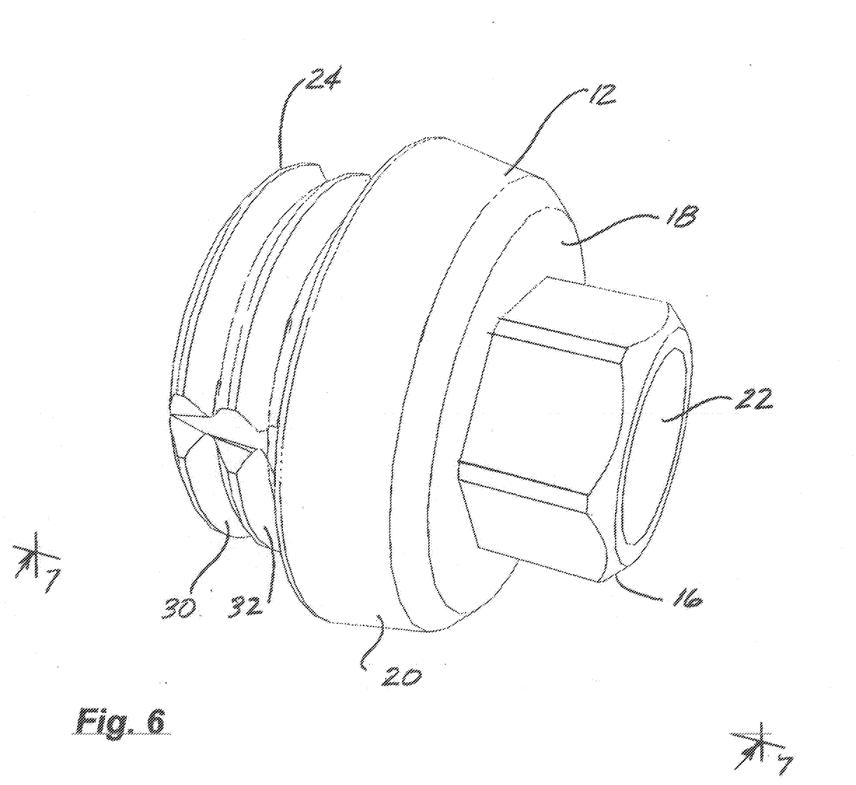

FIG. 7 is side elevation view of the substructure member taken along the line 7-7 of FIG. 6;

FIG. 8 is a view of the substructure member taken along the line 8-8 of FIG. 7; and

FIG. 9 is a cross-sectional view taken along the line 9-9 of FIG. 5.

### DETAILED DESCRIPTION OF THE INVENTION

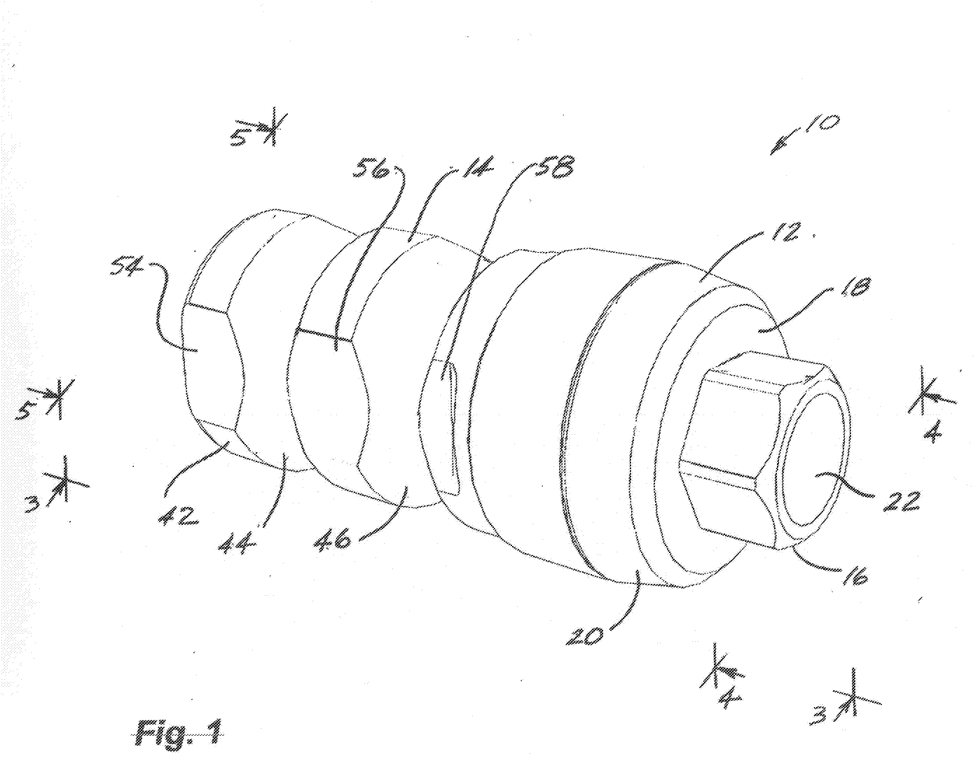

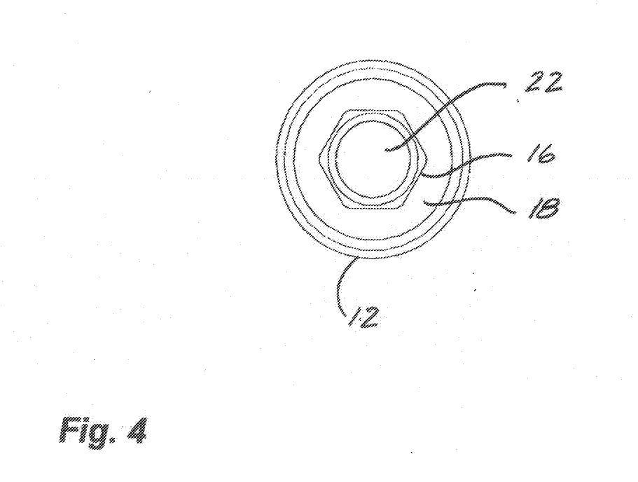

With reference to the drawings, there is shown in FIG. 1 a primary embodiment of the combination UCLA impression coping 10 according to the present invention which includes a metal substructure member 12 and a plastic chimney member 14. The metal substructure member 12 has an anti-rotation and indexing feature which is illustrated, by way of example, as a hexagonal projection 16 which projects from the surface 18 of a base portion 20. The substructure member 12 has a through bore 22 which is best shown in FIG. 4.

An attachment portion 24 projects from the surface 26 of the base portion 20. The attachment portion 24 is generally cylindrical and the surface 28 of the attachment portion 24 includes a plurality of undercuts or depressions which are illustrated, by way of example, as circumferential grooves 30, 32.

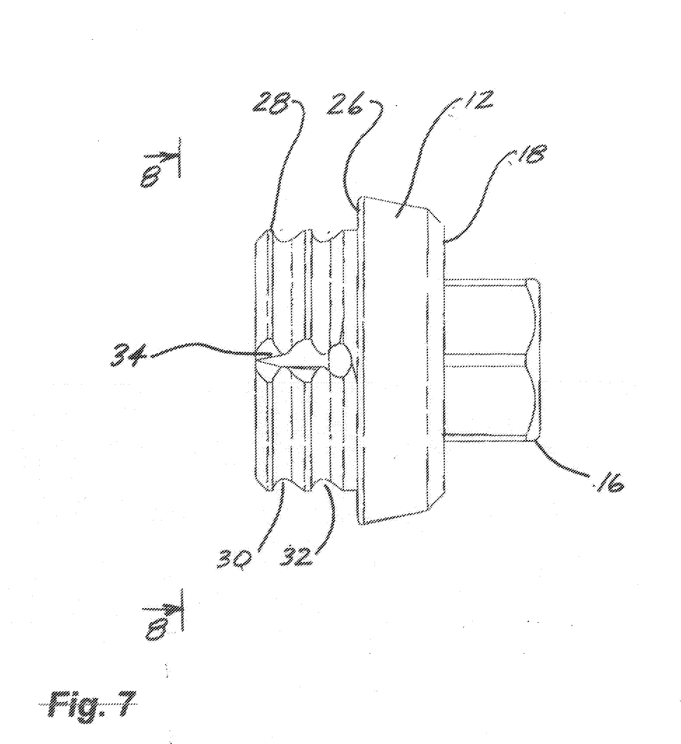

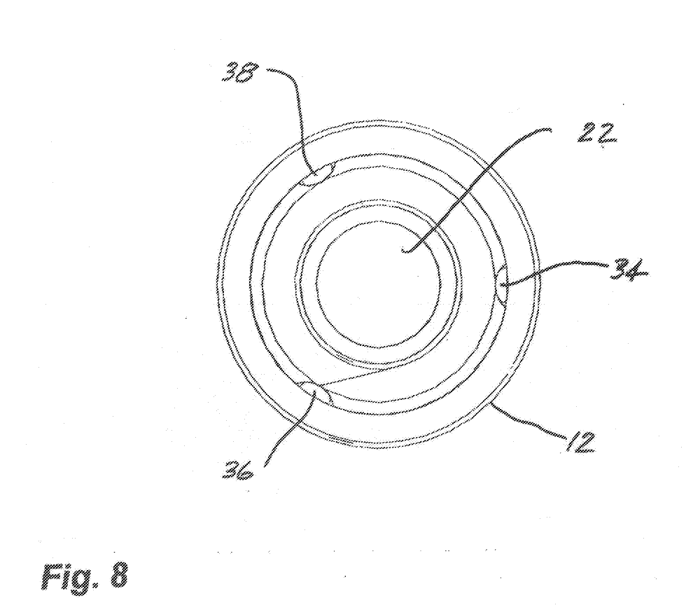

As is best shown in FIGS. 7 and 8, the attachment portion 24 also includes an anti-rotation feature which is illustrated as having the form of three longitudinal grooves 34, 36, 38.

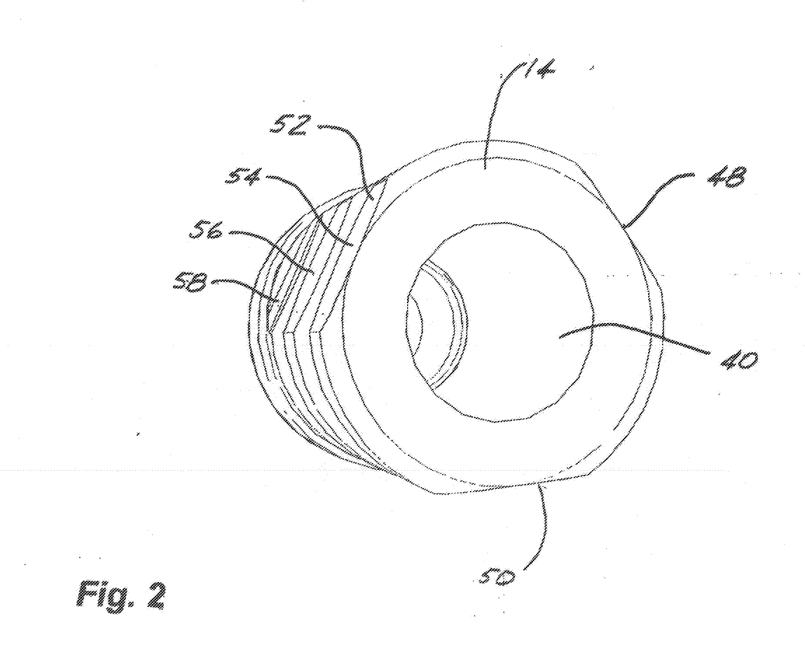

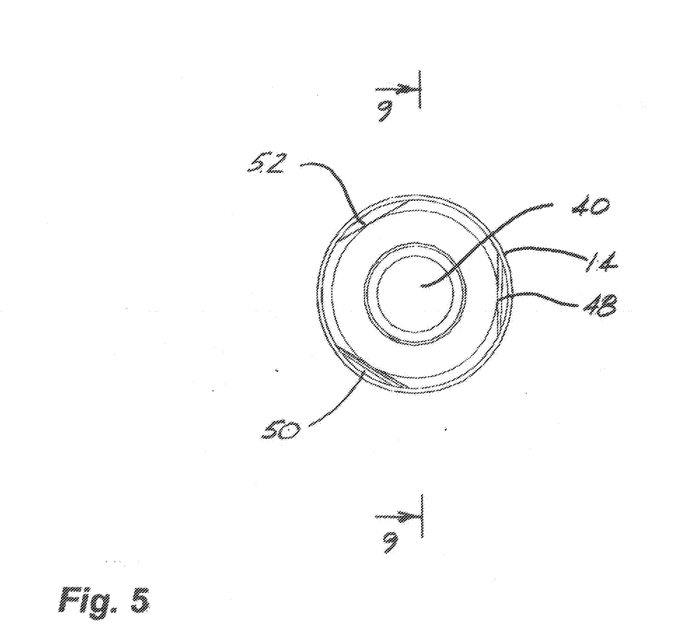

The circumferential grooves 30, 32 and the longitudinal grooves 34, 36, 38 provide a positive locking relationship between the metal substructure member 12 and the plastic chimney member 14 which is molded onto the attachment portion 24 to form the impression coping 10 as is shown in FIGS. 1-5.

The plastic chimney member 14 has the general configuration of a hollow cylinder having a through bore 40 which is in general alignment with the through bore 22 of the substructure member 12. The surface 42 of the plastic chimney member 14 has a snap-fit feature and an indexing feature which form key features of the present invention.

The snap-fit feature is shown, by way of illustration, as a pair of circumferential grooves 44, 46.

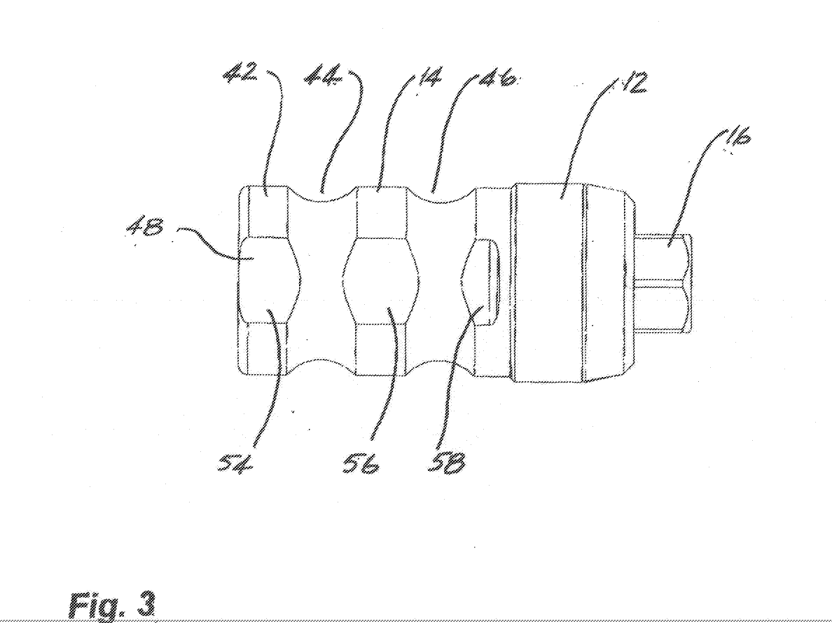

The indexing feature is best shown in FIGS. 1, 3 and 5 and includes three series of aligned flat portions 48, 50, 52. Each of the three series of aligned flat portions 48, 50, 52 include the flat portions which are typically illustrated by the flat portions 54, 56, 58 in FIG. 3.

The present invention thus provides a combination UCLA impression coping 10 which includes the following key features.

The first feature is a metal substructure 12 which has a precision anti-rotational fit with a dental insert. The dental insert is known in the art and has not been illustrated.

In the above example, this feature is illustrated by the hexagonal projection portion. Clearly, a range of anti-rotational features may be utilized including various flat portions projecting portions and indentation portions which cooperate with complementary portions to prevent relative rotation between the metal substructure 12 and a dental insert.

The second feature is a plastic chimney member 14 which has a snap-fit capability and an indexing feature which cooperates with a moldable rubber impression in a manner which will be presently described and in which the indexing feature has a fixed relationship relative to the hexagonal anti-rotational feature of the substructure member 12. The snap-fit capability is provided by the circumferential grooves 30, 32 and the indexing feature is provided by the flat portions 48, 50, 52, 54, 56, 58. It is clear that additional types of indexing features may be used including various types of projecting features and various types of indentation or local depression features.

The plastic chimney member 14 is made of a moldable plastic or polymer material which can be burned out during a casting process as will be presently described.

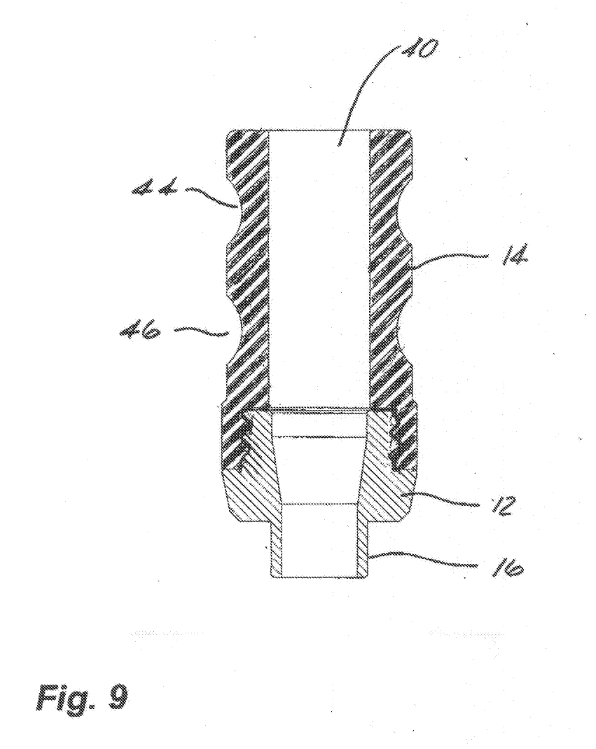

The impression coping 10 may be manufactured by a injection molding process in which the metal substructure member 12 is inserted in an injection mold cavity and plastic material is injected into the mold cavity for form the plastic chimney member 14 around the metal substructure member 12 as is best shown in FIG. 9. The injection molding process provides the combined advantages of a relatively high production rate, a relatively low unit cost and extremely high dimensional accuracy.

The present invention provides the following installation procedure for a combination UCLA impression coping 10 which is made according to the present invention.

The procedure for the installation of a combination UCLA impression coping 10 according to the present invention includes the following steps:
1) Inserting a dental implant in the patient's jawbone;
2) Attaching a combination UCLA impression coping 10 which includes a metal structure 12 which has a precision fit with the dental implant. The metal substructure 12 is connected to a plastic chimney portion 14 which includes an undercut. The attachment of the combination UCLA impression coping 10 is accomplished using a conventional fixation screw which passes through the bone in the combination UCLA impression coping 10. The fixation screw has not been illustrated.
3) Inserting a tray containing soft moldable rubber in the patient's mouth to capture the details of the combination UCLA impression coping 10.
4) Allowing the soft moldable rubber to flow into the undercut or groove portion to grab the plastic chimney portion 14 while the tray is in the patient's mouth.
5) Removing the combination UCLA impression coping 10.
6) Attaching the combination UCLA impression coping 10 to a replica of the dental implant.
7) Snap-fitting the combination UCLA impression coping 10 into the moldable rubber impression. The groove portions 44, 46 and the indexing features 48, 50, 52, 54, 56, 58 facilitate the precise location of the combination UCLA impression coping 10 relative to the patient's dentition.
8) Pouring a plaster model of the patient's mouth and attaching the combination UCLA impression coping 10 to the plaster model.
9) Reshaping the plastic chimney member 14 to form a dental prosthetic and custom casting the dental prosthetic. During the casting process, the plastic chimney member 14 is burned-out and the cast metal flows into the grooves 30, 32, 34, 36, 38 of the substructure member 12 thereby providing a positive lock.

The combination UCLA impression coping according to the present invention 10 thus eliminates the need to discard the conventional impression coping that is typically used to form the conventional plaster model.

The combination UCLA impression coping 10 may also be used as a temporary abutment by forming a temporary dental prosthetic on the plastic chimney member 14.

The foregoing specific embodiments of the present invention as set forth in the specification herein are for illustrative purposes only. Various deviations and modifications may be made within the spirit and scope of this invention, without departing from a main theme thereof.

What is claimed is:

1. A combination impression coping comprising:
an abutment component with said abutment component comprising:
a first end portion; and
a second end portion with said first end portion comprising
a first indexing geometry and with said second end portion comprising:
an attachment geometry;
a chimney member, with said chimney member attached to said attachment geometry of said abutment component and with said chimney member comprising:
a second indexing geometry, with said second indexing geometry having a fixed relationship relative to said first indexing geometry of said abutment component, and
an undercut geometry portion.

2. The combination impression coping according to claim 1 wherein said undercut portion comprises:
a snap-fit geometry portion.

3. The combination impression coping according to claim 1 wherein said abutment component comprises:
a metal abutment component.

4. The combination impression coping according to claim 1 wherein said abutment component comprises:
a non-metal abutment component.

5. The combination impression coping according to claim 1 wherein said chimney member comprises:
a plastic chimney member.

6. The combination impression coping according to claim 1 wherein said chimney member comprises:
a polymeric chimney member.

7. The combination impression coping according to claim 1 further comprising:
a thorough bore disposed extending through said chimney member and said abutment component.

8. The combination impression coping according to claim 1 wherein said first indexing geometry comprises:
a hexagonal portion.

9. The combination impression coping according to claim 1 wherein said second indexing geometry comprises:
at least one flat portion.

10. The combination impression coping according to claim 1 wherein said second indexing geometry comprises:
a plurality of flat portions.

11. The combination impression coping according to claim 1 wherein said chimney portion is generally cylindrical.

12. The combination impression coping according to claim 1 wherein said undercut portion comprises:
at least one groove portion.

13. The combination impression coping according to claim 1 wherein said undercut portion comprises:
a plurality of groove portions.

14. The combination impression coping according to claim 1 wherein said attachment geometry comprises:
at least one projecting portion.

15. The combination impression coping according to claim 1 wherein said chimney member forms a molded attachment to said attachment geometry of said abutment component.

16. The combination impression coping according to claim 1 wherein said chimney member comprises:
a burnout capable material.

17. The combination impression coping according to claim 1 wherein said chimney member is injection molded on said attachment geometry of said abutment component.

18. A method for forming a combination impression coping comprising the steps of:
forming a metal abutment having an attachment portion, and
injection molding a thermoplastic material over said attachment portion.

19. A method for fabricating a dental prosthetic comprising the steps of:
inserting a dental insert in a patient's bone;
inserting a combination impression coping into the dental insert, the combination impression coping having a proximal end with a first indexing geometry having a fixed reference relative to said dental insert and a distal end formed of polymer material and having an undercut portion and a second indexing geometry forming a fixed relationship relative to said first indexing geometry;
forming an impression of said dental insert, said combination impression coping and surrounding dentition, and constructing a dental prosthetic using said impression as a model.

20. A method for forming a temporary dental prosthetic comprising the steps of:
inserting a dental insert into a patient's bone;
inserting a combination impression coping into the dental insert, the combination impression coping having a proximal end made of metal, and a distal end made of polymer material; and
forming a temporary dental prosthetic on said distal end.

21. A combination impression coping for use with a dental implant having an indexing geometry comprising:
a metal abutment component having a proximal end;
an indexing geometry formed on said proximal end and matching said indexing geometry of said dental implant;
a polymer portion attached to said proximal end;
an indexing geometry formed on said polymer portion;
a central bore passing through said abutment component and said polymer portion; and an impression abutment portion formed on said polymer portion, with said indexing geometry on said proximal end of said abutment component having a fixed geometrical relationship relative to said indexing geometry on said polymer portion.

22. A method of forming a UCLA abutment comprising the steps of:
providing a metal abutment having an attachment portion, and
injection molding a plastic material onto said metal abutment.
